(19) United States
(12) Patent Application Publication
(10) Pub. No.: US 2014/0015836 A1
(43) Pub. Date: Jan. 16, 2014

(54) SYSTEM AND METHOD FOR GENERATING AND DISPLAYING A 2D PROJECTION FROM A 3D OR 4D DATASET

(71) Applicants: Anne Morawski Neubauer, Denver, CO (US); Willem Frederik Den Hartog, Singapore (SG); John Dougher Carroll, Littleton, CO (US); Onno Wink, Seattle, WA (US); Geert Antonius Franciscus Schoonenberg, Boekel (NL); Shiuh-Yung James Chen, Englewood, CO (US); Michael Grass, Buchholz in der Nordheide (DE)

(72) Inventors: Anne Morawski Neubauer, Denver, CO (US); Willem Frederik Den Hartog, Singapore (SG); John Dougher Carroll, Littleton, CO (US); Onno Wink, Seattle, WA (US); Geert Antonius Franciscus Schoonenberg, Boekel (NL); Shiuh-Yung James Chen, Englewood, CO (US); Michael Grass, Buchholz in der Nordheide (DE)

(73) Assignee: KONINKLIJKE PHILIPS ELECTRONICS N.V., Eindhoven (NL)

(21) Appl. No.: 13/990,905

(22) PCT Filed: Dec. 13, 2011
(86) PCT No.: PCT/IB2011/055631

§ 371 Date: Oct. 1, 2013

Related U.S. Application Data
(60) Provisional application No. 61/423,143, filed on Dec. 15, 2010.

(51) Int. Cl. G06T 11/00

(52) U.S. Cl. CPC G06T 11/003
USPC 345/427

(57) ABSTRACT

A system and method is described by which so-called standard angiographic views can be generated using a 3-or 4-D reconstructed image of the object of interest. One preferred example is the reconstruction of coronary angiograms from rotational angiography sequences. Once the 3D image is created, it can be forward projected into the user-defined “standard” views for live presentation during the procedure. It is anticipated that these standard views, which more closely mimic what a physician is accustomed to see, will be more readily accepted by the interventional community.

### FIELD OF THE INVENTION

The invention is related to a system for generating and displaying a 2D projection from a 3D or 4D dataset. The invention is further related to a method for generating and displaying such a 2D projection from a 3D or 4D dataset of the kind mentioned.

### BACKGROUND OF THE INVENTION

Methods have become available which permit the incorporation of volumetric or three-dimensional images, further abbreviated as 3D images, of coronary artery trees of the heart, also denoted as vessel trees, into cardiac catheterization laboratory during surgical interventional procedures, which, in the context of the present application, hereinafter means and reads as so-called minimally invasive interventional procedures. For instance, previously acquired data from cardiac computed tomography, further abbreviated as CT, or magnetic resonance imaging, further abbreviated as MRI, can be imported for use during the surgical interventional procedure, or a new technique which can produce a 3D image of the coronary artery tree during the actual surgical interventional procedure have been developed. The latter technique utilizes rotational angiography, where a so-called C-arm acquires many images while it rotates around the patient during contrast injection. After this, different strategies can be applied to the data, including two-view modelling, cardiac gating, least motion phase detection, and/or reconstruction to produce a 3D or a so-called 4D dataset live in the cardiac catheterization laboratory for a physician to use during the surgical interventional procedure. In this context, a 4D dataset means a number of 3D datasets being derived from the object to be represented one by one at defined time intervals. These datasets can be utilized for a variety of different purposes, including optimal viewing angle selection, three-dimensional quantitative coronary analysis, roadmapping, etc. However, physicians are typically accustomed to viewing static, that means not rotating, images of the coronary artery tree from certain standard, that means usual viewing angles and therefore, even if a 3D dataset is available, it may be underutilized such that additional static shots viewing the coronary artery tree in a two-dimensional manner may be acquired by the physician. This makes the procedure of generating a complete set of pictures of the coronary artery tree to be observed more complicated and time consuming, means additional discomfort to the patient and such leads to additional effort and costs.

From US-2006/0239554-A1 a system and method for automatically determining the standard cardiac image views as defined by the American Heart Association from volumetric data of the chest including the heart is known. The system and method can be used by a health practitioner to quickly see the two dimensional views from which a diagnosis is generally made. The left ventricle is detected. Then the relative orientation of the right ventricle is determined and the standard cardiac views are determined. In this system and method, the approach for automatically finding the standard cardiac views may be broken into two major parts, that is in a first step automatically detecting the left ventricle of the heart, and in a second step given the left ventricle of the heart, defining the orientation of the cardiac planes based on the long axis of the left ventricle and the direction of the right ventricle relative to the left ventricle.

### SUMMARY OF THE INVENTION

There may be a need to improve and simplify the procedure of generating a complete set of pictures of an object of interest to be observed and to make the data collected from the object of interest more suitable and comfortable for viewing by an operator or staff. Especially, there is a need to improve and simplify the procedure of generating a complete set of pictures of a coronary artery tree of a heart and to make the data collected from the coronary artery tree of the heart more suitable and comfortable for viewing by a physician.

These aspects of the invention are accomplished by the invention according to which a system is provided for generating and displaying at least one two-dimensional projection, hereinafter abbreviated as 2D projection, from a given dataset representing a 3D, that means three-dimensional, or 4D view of an object of interest, wherein control means are provided for individually user-customize one or more gantry angles from which the object of interest is viewed in the at least one 2D projection. In this context, a 4D dataset means a number of 3D datasets being derived from the object of interest to be represented one by one at defined time intervals.

The aspects of the invention are further accomplished by a method for generating and displaying at least one 2D projection from a given dataset representing a 3D or 4D view of an object of interest, wherein one or more gantry angles from which the object of interest is viewed in the at least one 2D projection are individually user-customized.

Especially, in a preferred embodiment of the system as well as of the method as described beforehand, said object of interest is formed by a vessel tree of coronary arteries of a heart.

The described system and method require that a 3D representation of the object of interest is available. It could have been created from a variety of different techniques. After the 3D representation is available, it can be forward projected into a 2D view that matches the viewing directions for the viewing angles as pre-defined by the user, and these images can then be displayed.

In the preferred embodiment, in which said object of interest is formed by a vessel tree of coronary arteries of a heart, either a 3D or also a 4D representation of the vessel tree of coronary arteries of a heart has to be available. This 3D or 4D representation can be created from techniques like modelling or reconstruction with any number of additional processing steps such as cardiac gating or motion compensation or even based on a pre-operatively acquired acquisition, for example older X-ray, computed tomography, also known as CT, or magnetic resonance imaging, also known as MRI. After being forward projected into a 2D view, the latter matches the viewing directions for the viewing angles as pre-defined by the physician. These images would then be displayed in room for the physician to utilize.

Such, a system and method by which so-called standard angiographic views can be generated using a 3D or 4D reconstructed image of the object of interest. These standard angiographic views can be individually customized by a physician; however, the standard angiographic views can also be firmly defined and carried out in the method and/or by the system. One example is the reconstruction of coronary angiograms from rotational angiography sequences. Once the 3D image is created, it can be forward projected into the individually user-defined or commonly given standard views for live presentation during the procedure. These standard views, which more closely mimic what the physician is accustomed to see, will be more readily accepted by the interventional community. The physician is thus given an easy way to utilize the 3D reconstruction in room using views which he would typically acquire if the 3D reconstruction were not available. The operator now has the opportunity to quickly assess the potential diagnostic quality of these standard views and deviate from them if deemed necessary, for example to reduce overlap and/or foreshortening.

With the system and method described beforehand, the procedure of generating a complete set of pictures of the coronary artery tree to be observed is improved and simplified, and the data collected from the coronary artery tree are made more suitable and comfortable for viewing by the physician.

In a further preferred embodiment of the method described beforehand, at least one of the one or more gantry angles is customized so as to equal those angles from which the object of interest is typically viewed using angiography. This is a preferred possible application. In the system described beforehand, accordingly, the mentioned control means for individually user-customize the one or more gantry angles are arranged in that way that at least one of the one or more gantry angles is customized so as to equal the angles from which the object of interest is typically viewed using angiography.

In another embodiment of the described method, the at least one 2D projection of the object of interest is displayed in addition to the dataset representing the 3D or 4D view of the object of interest. An accordingly constructed embodiment of the system described beforehand is provided with display means for displaying the at least one 2D projection of the object of interest in the respective manner.

The described system and method are preferably and advantageously used in the domain of interventional cardiology.

These and other aspects of the invention will be apparent from and elucidated with reference to the embodiments described hereinafter.

### BRIEF DESCRIPTION OF THE DRAWINGS

Embodiments of the invention will be described in more detail hereinafter in context with the accompanying drawings, in which

FIG. 1 shows, as an example, a 3D reconstructed image of a left coronary artery of a human heart as an object of interest together with three different forward projected 2D images produced from the 3D reconstructed image, and FIG. 2 shows an example for steps of a method for generating and displaying 2D projections from a given dataset representing a 3D or 4D view of an object of interest, which can be used to generate the 2D images as shown in FIG. 1.

### DETAILED DESCRIPTION OF EMBODIMENTS

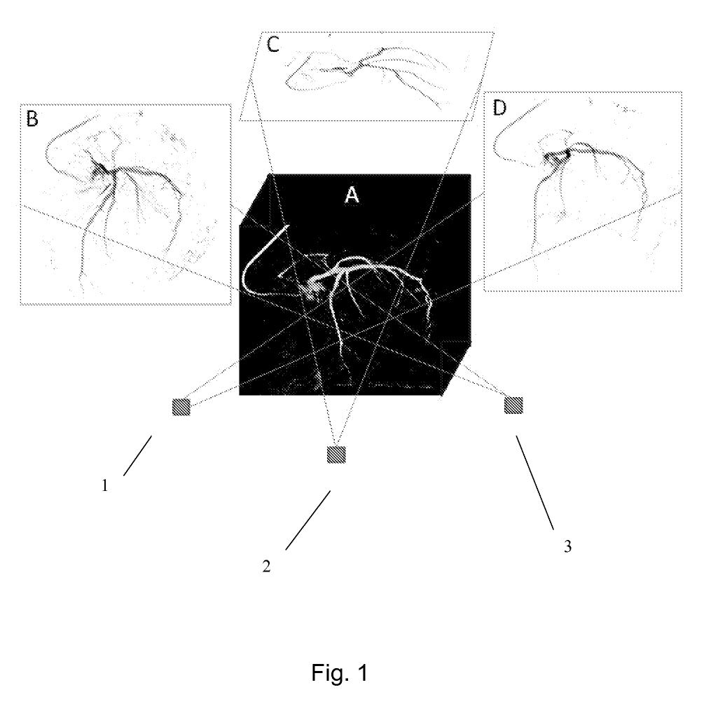

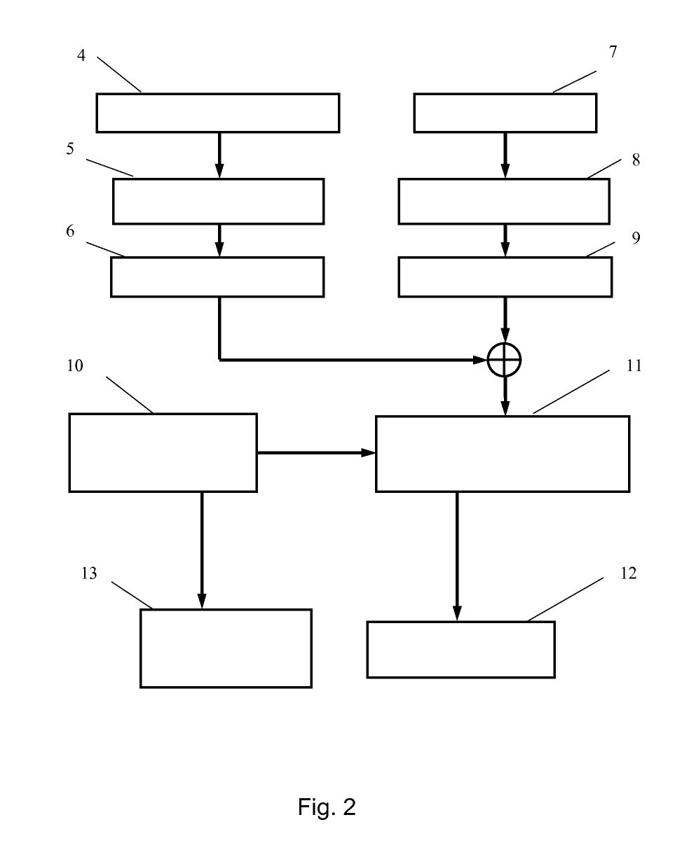

In FIG. 1, a 3D reconstructed image of a left coronary artery of a human heart serving as an object of interest in an embodiment of a system and method according to the invention is shown and denoted by reference numeral A. This 3D image can be derived from a single 3D dataset of the object of interest; however, it can also be understood as one out of a number of 3D datasets being derived from the object to be represented one by one at defined time intervals, the number of 3D datasets forming a 4D dataset. To generate different 2D projections from this given dataset representing the 3D view of the object of interest, that is the left coronary artery, different views denoted as view 1, view 2 and view 3 and marked with reference numerals 1, 2 and 3, respectively, are defined according to the desired perspectives from which the 3D reconstructed image is intended to be viewed. Then, based on these views 1, 2 and 3, respectively, three 2D projections are generated and displayed; these three different forward projected 2D images produced from the 3D reconstructed image are denoted as B, C and D, respectively, in FIG. 1. The views 1, 2 and 3 are chosen in that way that the three different forward 2D projected images B, C, and D, respectively, of the left coronary artery, are generated in a format made to look similar to a X-ray acquisition of this left coronary artery from pre-defined views commonly used in cardiology or angiography. However, also user-defined customization of the views 1, 2 and 3 is possible, or one or some of the views can be pre-defined and the other or others can be user-customized.

In FIG. 2, as an example, steps of a method for generating and displaying 2D projections from a given dataset representing a 3D or 4D view of an object of interest are shown. According to these steps, for example the 2D images as shown in FIG. 1 are generated. The embodiment of the method according to FIG. 2 is composed of the following steps.

1. In this first step, which in FIG. 2 is denoted by reference numeral 4, a number of so-called generic optimal view maps is pre-defined according to perspectives usually applied in angiography. These generic optimal view maps are preferably stored in the system for generating the 2D projections.

2. In a second step with the reference numeral 5 in FIG. 2, pre-defined standard gantry angles, also denoted as typical gantry angles, are developed from the generic optimal view maps. The resulting gantry angles to be used for further data processing are denoted in FIG. 2 with reference numeral 6.

3. In an alternative to the first step 4, the development of the gantry angles for producing the 2D projections is based on user customization, denoted by reference numeral 7 in FIG. 2. The corresponding alternative to the second step 5, that is the development of the gantry angles, is now denoted by reference numeral 8. This leads to individually defined gantry angles, denoted with reference numeral 9 in FIG. 2.

4. In a third step, in FIG. 2 denoted by reference numeral 10, a 3D or 4D image, that means a number of 3D images being derived from the object of interest, that is the coronary arteries, one by one at defined time intervals, is generated or imported using rotational angiography with reconstruction or pre-acquired data from CT or MRI.

5. In a fourth step, in FIG. 2 denoted by reference numeral 11, a 2D image is produced form the 3D or 4D dataset with the respectively defined viewing angles used for the projection direction of the respective 2D image. The techniques for performing this fourth step 11 are known per se; for example perspective projection or maximum intensity projection with the defined viewing angles can be used.

6. In a fifth step, denoted by reference numeral 12 in FIG. 2, the 2D images derived from the 2D projections are displayed to the user, for instance and preferably in the interventional suite. This is performed for instance additionally and parallel to the

7. sixth step, that is the display of the full dataset of the original 3D or 4D images, denoted by reference numeral 13 in FIG. 2.

A preferred, most direct application of the present invention is in the domain of interventional cardiology. The described system and method can be advantageously applied to enhance the utility of data resulting from for example X-ray equipment that has the capability of performing 3D reconstructions of coronary arteries.

Such, this invention describes a system and method by which so-called standard angiographic views can be generated using a 3- or 4-D reconstructed image of the object of interest. One preferred example is the reconstruction of coronary angiograms from rotational angiography sequences. Once the 3D image is created, it can be forward projected into the user-defined “standard” views for live presentation during the procedure. It is anticipated that these standard views, which more closely mimic what a physician is accustomed to see, will be more readily accepted by the interventional community.

### LIST OF REFERENCE NUMERALS

A 3D reconstructed image of a left coronary artery of a human heart serving as an object of interest
B first 2D projection generated and displayed from 3D reconstructed image A
C second 2D projection generated and displayed from 3D reconstructed image A
D third 2D projection generated and displayed from 3D reconstructed image A
1 view 1 according to a first perspective of the 3D reconstructed image A
2 view 2 according to a second perspective of the 3D reconstructed image A
3 view 3 according to a third perspective of the 3D reconstructed image A
4 first step of embodiment of method according to FIG. 2: defining generic optimal view maps
5 second step of embodiment of method according to FIG. 2: develop gantry angles
6 gantry angles resulting from second step 5 of embodiment of method according to FIG. 2: standard gantry angles
7 alternative to first step 4 of embodiment of method according to FIG. 2:

development of gantry angles based on user customization
8 alternative to second step 5 of embodiment of method according to FIG. 2: develop gantry angles
9 gantry angles resulting from alternative 8 to second step 5 of embodiment of method according to FIG. 2: individual gantry angles
10 third step of embodiment of method according to FIG. 2: generate or import a 3D (or 4D) image of the object of interest
11 fourth step of embodiment of method according to FIG. 2: produce a 2D image from the 3D (or 4D) dataset with the pre-defined viewing angles
12 fifth step of embodiment of method according to FIG. 2: Display 2D image of the object of interest
13 sixth step of embodiment of method according to FIG. 2: Display 3D (or 4D) image of the object of interest

1. System for generating and displaying at least one 2D projection (B, C, D) from a given dataset representing a 3D or 4D view (A) of an object of interest, wherein control means are provided for individually user-customize one or more gantry angles from which the object of interest is viewed in the at least one 2D projection (B, C, D);
wherein the system is configured to forward project an available 3D representation into a 2D view that matches the viewing directions for the viewing angles as pre-defined by the user; and
wherein display means are provided to display these images.

2. System according to claim 1,
in that said object of interest is formed by a vessel tree of coronary arteries of a heart.

3. System according to claim 1,
characterized in that said control means for individually user-customize the one or more gantry angles are arranged in that way that at least one of the one or more gantry angles is customized so as to equal those angles from which the object of interest is typically viewed using angiography.

4. System according to claim 1,
characterized in that display means are provided for displaying the at least one 2D projection of the object of interest in addition to the dataset representing the 3D or 4D view of the object of interest.

5. System according to claim 1,
characterized by a use in the domain of interventional cardiology.

6. Method for generating and displaying at least one 2D projection (B, C, D) from a given dataset representing a 3D or 4D view (A) of an object of interest, wherein one or more gantry angles (9) from which the object of interest is viewed in the at least one 2D projection are individually user-customized (7);
wherein an available 3D representation is forward projected into a 2D view that matches the viewing directions for the viewing angles as pre-defined by the user; and
wherein the 2D view is displayed.

7. Method according to claim 6,
characterized in that said object of interest is formed by a vessel tree of coronary arteries of a heart.

8. Method according to claim 6,
characterized in that at least one of the one or more gantry angles (9) is customized so as to equal those angles from which the object of interest is typically viewed using angiography.

9. Method according to claim 6,
characterized in that the at least one 2D projection (B, C, D) of the object of interest is displayed (12) in addition to the dataset representing the 3D or 4D view of the object of interest (13).

10. Method according to claim 6,
characterized by a use in the domain of interventional cardiology.
